(19) United States
(12) Patent Application Publication
(10) Pub. No.: US 2010/0106978 A1
(43) Pub. Date: Apr. 29, 2010

(54) DISPLAY DEVICE AND DISPLAY CONTENT SHARING METHOD

(75) Inventors: MING-TESUNG CHENG, Tu-Cheng (TW); LI-ZHANG HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/512,036

(22) Filed: Jul. 30, 2009

(30) Foreign Application Priority Data
Oct. 24, 2008 (CN) 200810305192.1

(51) Int. Cl. H04L 9/00; H04K 1/00; G06F 12/14

(52) U.S. Cl. 713/189; 380/270

(57) ABSTRACT

This present disclosure provides a display device and a display content sharing method by employing the display device, the display device includes a storage unit and a display unit, the display content sharing method includes: obtaining an identity code of a wireless communication device; obtaining encrypted digital content of the identity code in the storage unit; decrypting the encrypted digital content of the identity code; displaying the decrypted content on the display unit.

### BACKGROUND

1. Technical Field

The present disclosure relates to a display device and a display content sharing method using the display device.

2. Description of Related Art

Usually, when different people share a same display device such as a digital photo frame (DPF), it is not convenient. To keep it secure, people must manually enter a password to access their user specific content.

### BRIEF DESCRIPTION OF THE DRAWINGS

The components in the drawings are not necessarily drawn to scale, the emphasis instead being placed upon clearly illustrating the principles of the display device and the display content sharing method. Moreover, in the drawings, like reference numerals designate corresponding parts throughout the several views.

FIG. 1 is a block diagram of a hardware infrastructure of a display device, in accordance with an exemplary embodiment.

FIG. 2 is a diagram showing associating relationships between identity codes and corresponding digital contents, in accordance with an exemplary embodiment.

FIG. 3 is a flowchart of a display content sharing method, in accordance with an exemplary embodiment.

FIG. 4 is a flowchart of a registration process of FIG. 3.

FIG. 5 is a flowchart of a display content sharing process of FIG. 3.

### DETAILED DESCRIPTION OF THE EMBODIMENTS

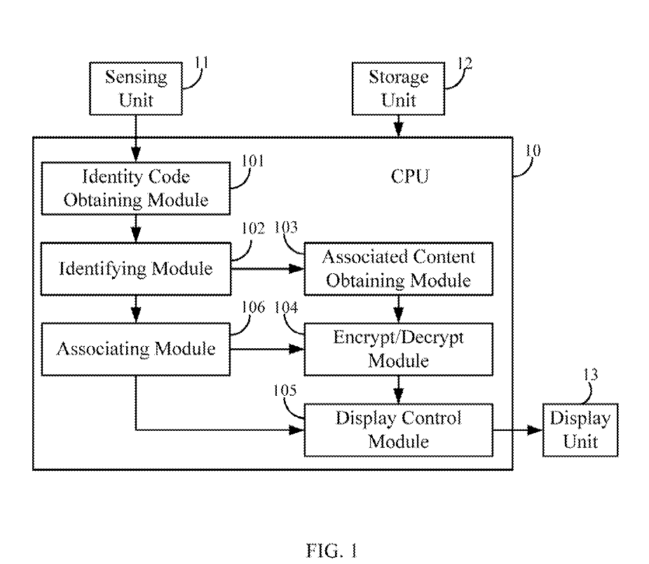

FIG. 1 is a block diagram of a hardware infrastructure of a display device, in accordance with an exemplary embodiment. The display device includes a central processing unit (CPU) 10, a storage unit 12, and a display unit 13.

The storage unit 12 is configured to store digital contents. The display unit 13 is configured to display the digital contents stored in the storage unit 12.

The display device further includes at least one sensing unit 11. The sensing unit 11 is configured to detect wireless signals that are generated by a wireless communication device near the display device. The wireless communication device may be a mobile phone, a personal digital assistant (PDA), a laptop computer and so on. The wireless communication device may use wireless technology based on RF, IR, Wi-Fi, and so on. In this exemplary embodiment, the wireless communication device is a BLUETOOTH enabled device as an example.

The CPU 10 includes an identity code obtaining module 101, an identifying module 102, and an associated content obtaining module 103. The identity code obtaining module 101 is configured to obtain an identity code of the wireless communication device from the wireless signals which are detected by the sensing unit 11. The identity code is a BLUETOOTH device address (BD_ADDR) of the wireless communication device. The identifying module 102 is configured to determine whether the identity code obtained by the identity code obtaining module 101 associates one stored in the storage unit 12, and the identifying module 102 is further configured to determine whether the BLUETOOTH enabled device is registered. The BLUETOOTH enabled device is registered when the identity code does associate the device with one stored in the storage unit 12, and the BLUETOOTH enabled device is unregistered when the identity code cannot associate the device with one stored in the storage unit 12. The associated content obtaining module 103 is configured to obtain a digital content that is associated with the identity code when the BLUETOOTH enabled device is registered.

The CPU 10 further includes a display control module 105 and a associating module 106. The display control module 105 is configured to control displaying the associated digital contents on the display unit 13; the associating module 106 is configured to set relationships between the identity codes and the digital contents, then store the identity codes and the associated digital contents in the storage unit 12. The display control module 105 is further configured to control the display unit 13 to display a setting process. The associated digital contents are the digital contents that the user wants to display when the sensing unit 11 detects the wireless communication device again. The type of the associated digital contents can be images, texts, videos, and so on. In this exemplary embodiment, the associated digital contents include the associated digital contents and identification information of the associated digital contents. For example, identification information is the name of an image.

In another exemplary embodiment, the CPU 10 may further includes an encrypt/decrypt module 104, the encrypt/decrypt module 104 is configured to encrypt the associated digital contents corresponding to the identity code, and decrypt the encrypted digital contents corresponding to the identity code. Each identity code is corresponding to a unique encryption key and a unique decryption key.

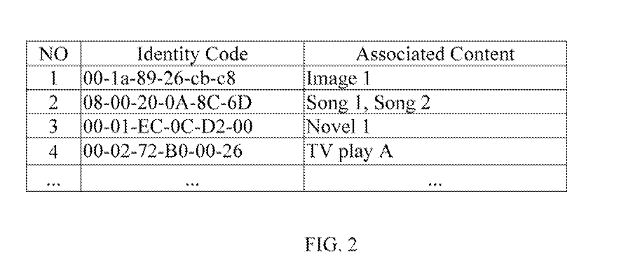

FIG. 2 is a diagram showing associating relationships between identity codes and the corresponding digital contents, in accordance with an exemplary embodiment. The relationships between the identity codes and the digital contents are explained. Serial number 1 identity code “00-1a-89-26-cb-c8” corresponding to Image 1, then the associated digital content of the identity code “00-1a-89-26-cb-c8” is the Image 1. Serial number 2 identity code “08-00-20-0A-8C-6D” corresponding to Song 1 and Song 2, then the associated digital contents of the identity code “08-00-20-0A-8C-6D” are Song 1 and Song 2. Serial number 3 identity code “00-01-EC-0C-D2-00” corresponding to a Novel 1, then the associated digital content of the identity code “00-01-EC-0C-D2-00” is the Novel 1. Serial number 4 identity code “00-02-72-B0-00-26” corresponding to a TV play A, then the associated digital content of the identity code “00-02-72-B0-00-26” is the TV play A.

When a Bluetooth enabled device is near the display device, the sensing unit 11 of the display device detects BLUETOOTH signals generated by the BLUETOOTH enabled device, the identity code obtaining module 101 obtains BD_ADDR, for example, “00-1a-89-26-cb-c8” as the identity code. The associating module 106 associates the identity code with Image 1 that is saved in the storage unit 12. The encrypt/decrypt module 104 encrypts the Image 1 with the unique encryption key and saves the encrypted image into the storage unit 12. When the BLUETOOTH enabled device is near the display device next time, the sensing unit 11 detects the BLUETOOTH signals of the BLUETOOTH enabled device, the identity code obtaining module 101 obtains identity code “00-1a-89-26-cb-c8” from the BLUETOOTH signals. The identifying module 102 determines that the user is registered when the identity code is in the storage unit 12. The associated content obtaining module 103 obtains the encrypted image. The encrypt/decrypt module 104 decrypts the encrypted image with the unique decryption key. The display control module 105 controls the display unit 13 to display the decrypted image.

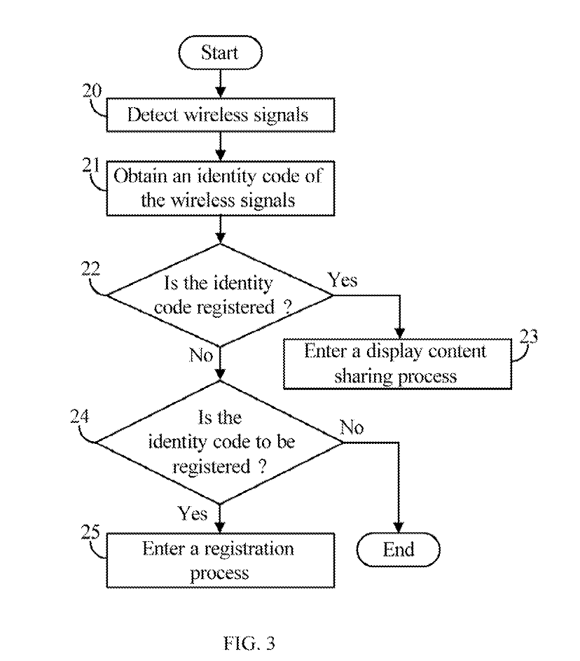

FIG. 3 is a flowchart of a display content sharing method in accordance with an exemplary embodiment.

In step 20, the sensing unit 11 detects wireless signals which are generated by a wireless communication device near the display device.

In step 21, the identity code obtaining module 101 obtains an identity code of the wireless communication device from the wireless signals which are detected by the sensing unit 11.

In step 22, the identifying module 102 determines whether the identity code obtained by the identity code obtaining module 101 is stored in the storage unit 12, if “yes”, the wireless communication device is registered, then step 23 is next, if “no”, the wireless communication device is unregistered, then step 24 is next.

In step 23, the procedure enters a display content sharing process.

In step 24, the identifying module 102 prompts user to decide whether to register their device's identity code. When the user chooses not to register for the registered identity code, then the procedure ends.

In step 25, when the user chooses to register the registered identity code, the procedure enters a registration process.

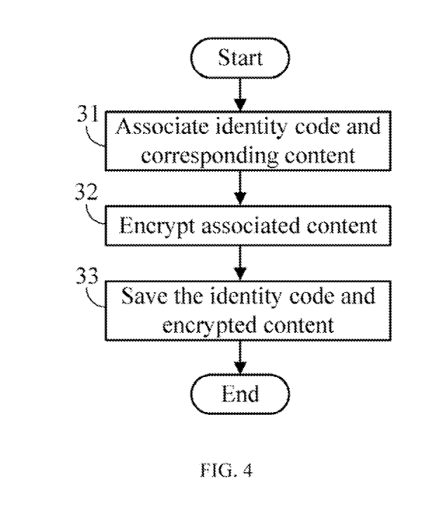

FIG. 4 is a flowchart of registration process of FIG. 3. The flowchart of registration includes steps: Step 31, the associating module 106 sets the relationships between the identity codes and the digital contents.

In step 32, the encrypt/decrypt module 104 encrypts the digital contents with a unique encryption key.

In step 33, The encrypt/decrypt module 104 saves the identity code and the encrypted digital contents into the storage unit 12.

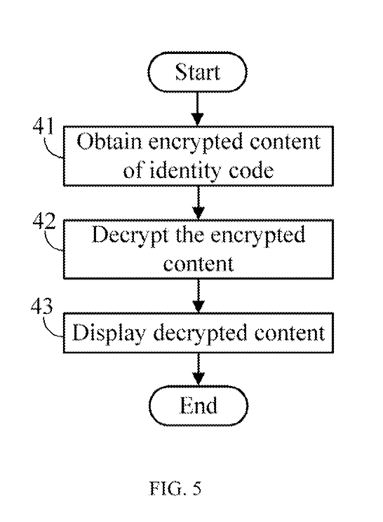

FIG. 5 is a flowchart of display content sharing process of FIG. 3. The flowchart of display content sharing includes following steps: Step 41, the associated content obtaining module 103 obtains the encrypted contents associated with the identity code. In step 42, the encrypt/decrypt module 104 decrypts the encrypted contents with a unique decryption key.

In step 43, the display control module 105 controls the display unit 13 to display the decrypted contents.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the disclosure.

What is claimed is:

1. A display device comprising:
a storage unit configured to store digital contents;
a display unit configured to display the digital contents stored in the storage unit;
a sensing unit configured to detect wireless signals generated by a wireless communication device near the display device;
an identity code obtaining module configured to obtain an identity code of the wireless communication device from the wireless signals which is detected by the sensing unit;
an identifying module configured to determine whether the identity code obtained by the identity code obtaining module is stored in the storage unit, and determine whether the wireless communication device is registered;
an associating module configured to set relationship between the identity code and a digital content in the storage unit;
an associated content obtaining module configured to obtain encrypted digital content of the identity code, when the wireless communication device is registered;
an encrypt/decrypt module configured to encrypt the associated digital content which is obtained by the associating module or decrypt the encrypted digital content which is obtained by the associated content obtaining module;
a display control module configured to control displaying the associated digital content.

2. The display device as described in claim 1, wherein each identity code is corresponding to a unique encryption key and a unique decryption key.

3. The display device as described in claim 1, wherein the wireless communication device communicates with the display device based on BLUETOOTH, RF, IR, or Wi-Fi.

4. The display device as described in claim 1, wherein the wireless communication device is a mobile phone, a personal digital assistant (PDA), or a laptop computer.

5. The display device as described in claim 1, wherein the associated digital contents displayed on the display unit include the associated digital contents and the identification information of the associated digital contents.

6. The display device as described in claim 1, wherein the type of the associated digital contents can be images, texts, or videos.

7. A display content sharing method by employing a display device, the display device comprising a storage unit and a display unit, the method comprising:
obtaining an identity code of a wireless communication device;
obtaining encrypted digital content associated with the identity code in the storage unit;
decrypting the encrypted digital content of the identity code;
displaying the decrypted content on the display unit.

8. The display content sharing method as described in claim 7, wherein each identity code is corresponding to a unique decryption key.

9. A display content sharing method by employing a display device, the display device comprising a storage unit, the method comprising:
obtaining an identity code of a wireless communication device;
setting a associated digital content for the identity code in the storage unit;
encrypting the associated digital content of the identity code;
saving the encrypted digital content in the storage unit.

10. The display content sharing method as described in claim 9, wherein each identity code is corresponding to a unique encryption key.
